(19) United States
(12) Patent Application Publication
(10) Pub. No.: US 2007/0215745 A1
(43) Pub. Date: Sep. 20, 2007

(54) METHOD OF IMPROVING AERONAUTICAL SAFETY RELATING TO AIR/GROUND COMMUNICATIONS AND TO THE ENVIRONMENT OF AIRCRAFT

(75) Inventors: Stephane Fleury, Colomiers (FR); Didier Lorido, Plaisance du Touch (FR); Nicolas Marty, Saint Sauveur (FR)

Correspondence Address: LOWE HAUPTMAN & BERNER, LLP, 1700 DIAGONAL ROAD, SUITE 300, ALEXANDRIA, VA, 22314, US

(73) Assignee: THALES, NEUILLY-SUR-SEINE (FR)

(21) Appl. No.: 11/686,344

(22) Filed: Mar. 14, 2007

(30) Foreign Application Priority Data
Mar. 14, 2006 (FR) 06 02215

(51) Int. Cl. B64C 37/02

(52) U.S. Cl. 244/2

(57) ABSTRACT

The method in accordance with the invention is a method of improving aeronautical safety relating to air/ground communications and to the environment of aircraft and it is characterized in that the quality of the air/ground exchanges between the crew and an air traffic control center is monitored automatically aboard the aircraft in which this method is implemented, that the context arising from these exchanges is correlated with the onboard data and those produced by the monitoring of the environment of the aircraft, and that warnings destined for the crew of the aircraft are formulated by allocating these messages a severity level as a function of the degree of dangerousness of a detected threat and/or of gaps or inconsistencies between the instructions and information from the control center and the flight parameters of the aircraft or the intentions of its crew and/or messages destined for the air traffic control.

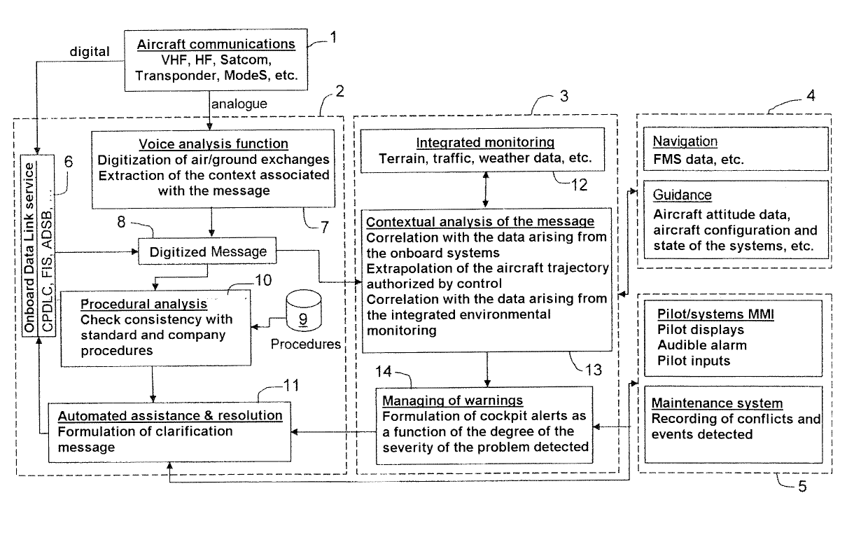

### CROSS-REFERENCE TO RELATED APPLICATIONS

The present Application is based on French Application No. 06 02215, filed on Mar. 14, 2006 and priority is hereby claimed under 35 USC §119 based on this application. Each of these applications are hereby incorporated by reference in their entirety into the present application.

### BACKGROUND OF THE INVENTION

1) Field of the Invention

The present invention pertains to a method of improving aeronautical safety relating to air/ground communications and to the environment of aircraft.

2) Description of Related Art

According to several recent accident reports, a main contributory or direct cause is related to inappropriate communications between the air traffic control centers and the crew of the aircraft involved. This results in a difference of interpretation between the controller and the pilot, which difference may remain undetected until an incident or an accident.

Currently, such risks are taken into account by virtue of a standardized air/ground communication syntax (PAN/RAC standard) and by virtue of the continuous training of pilots and air traffic controllers in the field of flight management and the prevention of “CFITs”. However, numerous recent analyses of incidents and accidents show that ambiguous air/ground exchanges persist on account of non-compliance with these procedures and precautions.

### SUMMARY OF THE INVENTION

The present invention is aimed at a method of improving aeronautical safety relating to air/ground communications and to the environment of aircraft making it possible, when an instruction or an item of information from the air traffic controller is incompatible with the flight parameters of the aircraft in question, to immediately raise an alert signaling this conflict, so as to detect any ambiguity in the air/ground exchanges so as to inform the crew of information missing from the instructions received or implicit limitations of the latter, thus allowing the crew to clarify or to resume the exchange of information with the controller, so that the latter's intentions are the same as those of the pilot.

The method in accordance with the invention is characterized in that the quality of the air/ground exchanges between the crew and an air traffic control center is monitored automatically aboard the aircraft in which this method is implemented, that the context arising from these exchanges is correlated with the onboard data and those produced by the monitoring of the environment of the aircraft, and that warnings destined for the crew of the aircraft are formulated by allocating these messages a severity level as a function of the degree of dangerousness of a detected threat and/or of gaps or inconsistencies between the instructions and information from the control center and the flight parameters of the aircraft or the intentions of its crew and/or messages destined for the air traffic control.

### BRIEF DESCRIPTION OF THE DRAWINGS

The present invention will be better understood on reading the detailed description of an embodiment, taken by way of non-limiting example and illustrated by the appended drawing, in which the single FIGURE is a block diagram of an exemplary device for implementing the method of the invention.

### DETAILED DESCRIPTION OF THE INVENTION

The method of the invention consists mainly in automatically monitoring the air/ground exchanges aboard the aircraft in which this method is implemented with the aim of detecting the inconsistencies mentioned above in the preamble and of remedying same by signaling them to the crew so as to allow the latter to clarify or to resume the exchange of information with the controller, so that the latter's intentions are understood and consistent with those of the crew.

The method of the invention uses the communicating capabilities of aircraft (in particular all digital communications of “Data Link” type and/or based on voice analysis of analogue communications of VHF, HF, Satcom type), onboard environmental monitoring capabilities (such as TAWS, TCAS, weather radar, ISS, etc.), the navigation system of the aircraft as well as control and management systems of the aircraft. It consists essentially in analyzing the messages originating from ground control received by the crew by means of the said communicating capabilities and in correlating the data produced by this analysis with the analysis of the flight parameters of the aircraft and of the grave threats (traffic, terrain and meteorology). This correlation is performed according to a principle of comparing exchanges between pilots and the ground with, initially, the standardized radio exchange procedures (PAN/RAC, CPDLC) and company procedures by virtue of a contextual analysis so as to detect an exchange of ambiguous or incorrect information (collation not performed, ambiguous syntax, inaccuracy or absence of critical information in an authorization from control, etc). Subsequently, the key data arising from the exchange between the crew and the ground are correlated with the onboard information so as to evaluate the applicability thereof in relation to the constraints of the aircraft (monitoring of the environment, performance of the aircraft, intention of the pilots, etc). This correlation makes it possible to formulate various displays, alarms and messages according to the nature of the inconsistency detected. According to an advantageous aspect of the invention, the said key data are extracted by implementing the standardized classification architecture arising from the CPDLC, since this definition makes it possible to extract fundamental parameters of standardized air-ground exchanges.

The various functions implemented on board the aircraft by the method of the invention have been illustrated in the block diagram of the single FIGURE. These functions comprise essentially: communication means 1, a system 2 for managing communications (CMU or ATSU), a system 3 for integrated environmental monitoring of ISS type means 4 for controlling and managing the aircraft (trim control, configuration control, navigation management, etc.), as well as display, alarm (audible and/or visual for example) and recording means 5

The system 2 for managing communications relates in particular to the analysis and to the digitizing of voice messages, to the interpreting of digital air-ground messages or ones previously digitized so as to extract there from the fundamental parameters allowing syntactic and procedural control, including the pre-formatting and the possible proposing of messages of clarification or of refusal of the directives from the controller to the crew.

The integrated environmental monitoring system 3 formulates the context associated with the digitized message and performs its correlation with the associated aircraft parameters (search for environmental threats around the proposed aircraft trajectory if the message relates to a navigation authorization, search for inconsistencies between the data of the ground control and those of the onboard systems, insufficient performance, erroneous crew selections, etc.) and finally with the formulation of more or less significant alerts destined for the crew and/or the in-flight recording or maintenance systems (forming part of the means 5) according to the degree of severity of the problem detected.

In detail, the means 1 to 5 cited above are the following. The communication media 1 include all the communication means generally available on board an aircraft: VHF, HF, Satcom, transponder, Mode S communications, etc.

The system 2 for managing communications comprises on board digital communications services 6 supported by applications of CPDLC, FIS, ADSB type, etc. It provides the calculation means allowing the formulation of a digitized message 8, either by the implementation of a device 7 for analysis and voice recognition of the air/ground exchanges received by the communication media 1 of the aircraft, or by the digital communication services 6 managing the digital air/ground data exchanges. It should be noted that the device 7 can be configured so as to support several languages and that the digital message 8 is not dependent on the language used, but only on the standardized procedures.

On the basis of the messages 8 thus obtained, a procedural analysis module 10 checks the quality of the Air/Ground exchanges with respect to the procedures in force stored in the system 9 (default standard procedures or configuration-based company procedures of the system 2) so as to search for ambiguities or procedure errors. Finally, for such cases, an assistance and resolution module 11 informs the crew about any ambiguity or error and may propose a possible resolution by displaying it with the aid of the means 5. The crew can thus either accept or modify the digital clarification message generated then authorize the sending thereof with the aid of the onboard digital communication services 6, or use the resolution proposal as guide while contacting ground control directly via its conventional means of communication 1.

It is seen therefore that the “Data Link” service 6 may possibly be used to effect a pre-formatting of digital clarification messages intended for the air traffic controller, but which are dispatched to the controller only on the decision of the crew. This pre-formatting consists essentially in producing a request for clarification (as a consequence of an ambiguity of the messages received on board or of poor comprehension) and, if appropriate, in rejecting a request or authorization of the controller (message of the type “Unable due to weather” or “unable due to aircraft performance”). It should be noted that this module can also be used in the case where the contextual analysis of the ground message carried out by the module 13 detects an impossibility with respect to the possibilities of the aircraft.

The integrated monitoring system 3 (AESS, ISS, T3CAS, etc.) comprises conventional monitoring means 12 such as TAWS, TCAS, ACAS, ASAS Weather radars, AESS, IS, etc. On the basis of the digitized message 8, the contextual analysis module 13 extracts the context associated with the message (impact on the aircraft trims, its trajectory, its performance, etc.). This contextual information is on the one hand correlated with the information provided by the flight management and control system 4 so as to detect an inconsistency between the information received and that of the onboard systems of the aircraft. For example, an authorization to descend to an altitude below the admissible minima in the current configuration of the aircraft. Moreover, the module 13 extrapolates an aircraft trajectory as a function of the context arising from the digitized message 8 and correlates it with the data arising from the integrated monitoring system 12, so as to detect a possible environmental threat around the future trajectory.

For example, the correlation established between the trajectory extrapolated on the basis of a controller navigation directive received in the message and the integrated monitoring data locating a threat around this trajectory (for example the proximity of obstacles, of turbulence, or even a future non-compliance with a safety altitude with respect to the relief) makes it possible to determine the distance between this threat and the aircraft and/or the time remaining before this threat turns into an incident or accident and therefore makes it possible to aid the crew in the evaluation of the degree of acceptability of the directive arising from ground control.

If appropriate, a device 14 for formulating information or alerts intended for the crew of the aircraft in the event of detected inconsistencies may, according to the degree of severity of the inconsistency, simply record the incident through the onboard maintenance computer (so as to contribute to the improving of preventive measures and/or to the training measures of the airline), signal the inconsistency to the pilot or finally, in the event of serious anomaly, alert the pilot so as to alleviate an immediate danger. These warnings/alerts (audible and/or visual for example) are intended to attract the attention of the crew in the event of imminent danger and are classified as a function of the gravity of the aircraft's situation and as a function of other flight parameters (flight phase, state of the aircraft, etc.). In other words, these warnings are allocated an order of severity in accordance with the standards in force relating to the priority of such warnings according to the nature of the threat. The device 14 formulates these severity orders on the basis of the information provided to it by the device 13 and of the nature of the system function at issue, such as specified by the regulations in force.

The data formulated by the circuit 14 are dispatched to the means 5 and may, on the decision of the crew, make it possible to generate a confirmation/clarification/rejection message dispatched to the controller by virtue of the means 11. The means 4 comprise various devices relating to the man-machine interface (MMI) of the pilots and to the onboard computers. These various devices are, in a non-limiting manner: the usual display instruments of the flight deck, audible alarms and maintenance or flight recorders recording the various anomalies. The information displayed by the relevant display instruments on the basis of the data originating from the circuit 14 can be displayed in the conventional form, or else in a special signpost form (new form, color or dimensions, chosen as a function of the significance of the danger).

According to another non-limiting example, the method of the invention produces the following actions on receipt of a message from the air traffic controller of the type “DESCEND TO FL030”: detect a possible collision in flight, detect non-compliance with a safety altitude or an insufficient margin in relation to the terrain or obstacles, detect a risk related to the meteorological conditions, attract the attention of the pilots to the ambiguity of a message which does not specify when, or from what point onwards, the authorization to descend is granted etc.

1. A method of improving aeronautical safety relating to air/ground communications and to the environment of aircraft, comprising the steps of: automatically monitoring the quality of the air/ground exchanges aboard the aircraft between the crew and an air traffic control center correlating the context arising from these exchanges with the onboard data and those produced by the monitoring of the environment of the aircraft, and formulating warnings destined for the crew of the aircraft by allocating these messages a severity level as a function of the degree of dangerousness of a detected threat and/or of gaps or inconsistencies between the instructions and information from the control center and the flight parameters of the aircraft or the intentions of its crew and/or messages destined for the air traffic control.

2. The method according to claim 1, characterized in that the quality of the air/ground exchanges is monitored with respect to the procedures in force.

3. The method according to claim 2, wherein the procedures in force are standardized default procedures.

4. The method according to claim 2, wherein the procedures in force are configuration-based company procedures.

5. The method according to claim 1, wherein each directive from the ground is interpreted and gives rise to an analysis allowing the crew to evaluate the acceptability thereof.

6. The method according to claim 1, wherein the monitoring of the digital air/ground exchanges is carried out with the aid of the Data Link services of the aircraft.

7. The method according to claim 1, wherein the monitoring of the voice air/ground exchanges is carried out with the aid of a voice recognition system.

8. The method according to claim 1, wherein the formulated warnings destined for the crew of the aircraft are visual messages.

9. The method according to claim 1, wherein the formulated warnings destined for the crew of the aircraft are audible messages.

10. The method according to claim 8, wherein the formulated warnings destined for the crew of the aircraft are also dispatched to the maintenance and/or flight recorders of the aircraft.

11. The method according to claim 1, wherein the formulated messages destined for the control center on the decision of the crew are automatically pre-formatted and comprise clarification requests and/or ambiguous or incorrect message rejections.

12. The method according to claim 7, wherein the voice recognition system is configured so as to support several languages.

13. The method according to claim 9, wherein the formulated warnings destined for the crew of the aircraft are also dispatched to the maintenance and/or flight recorders of the aircraft.

14. The method according to claim 2, wherein the formulated messages destined for the control center_on the decision of the crew are automatically pre-formatted and comprise clarification requests and/or ambiguous or incorrect message rejections.

15. The method according to claim 3, wherein the formulated messages destined for the control center on the decision of the crew are automatically pre-formatted and comprise clarification requests and/or ambiguous or incorrect message rejections.

16. The method according to claim 2, wherein the monitoring of the voice air/ground exchanges is carried out with the aid of a voice recognition system.

17. The method according to claim 3, wherein_the monitoring of the voice air/ground exchanges is carried out with the aid of a voice recognition system.

18. The method according to claim 2, wherein the formulated warnings destined for the crew of the aircraft are visual messages.

19. The method according to claim 3, wherein the formulated warnings destined for the crew of the aircraft are visual messages.

20. The method according to claim 4, wherein the formulated warnings destined for the crew of the aircraft are visual messages.
